(19) United States
(12) Patent Application Publication
(10) Pub. No.: US 2012/0212897 A1
(43) Pub. Date: Aug. 23, 2012

(54) PORTABLE STORAGE DEVICE

(76) Inventor: Yu-Nan LO, Taichung City (TW)

(21) Appl. No.: 13/032,964

(22) Filed: Feb. 23, 2011

(51) Int. Cl. G06F 1/16

(52) U.S. Cl. 361/679.31

(57) ABSTRACT

A portable storage device comprises a memory device, a housing and a locking mechanism. The memory device includes an upper and a lower covers, and a memory with one end clamped therebetween, and another end of the memory is an USB connector for connecting to computer. The housing is provided with two ears at both sides thereof, and each of the ears is formed with a through hole. The locking mechanism comprises a flexible member, and both ends of the flexible member being formed with a locking portion, each of the locking portions is inserted through the through holes of the ears and engaged with a locking members, respectively. The locking portions of the flexible member are formed with outer threads for meshing with inner threads of the locking member. The portable storage device can also be used to carry small objects in addition to being used as storage device.

### BACKGROUND OF THE INVENTION

1. Field of the Invention

The present invention relates to a portable storage device, and more particularly to an easily-portable storage device which can also be used to carry small objects.

2. Description of the Prior Art

To reduce storage space or prevent data loss, people will use portable storage, people will use portable storage device to save digital data. Currently, the most commonly used portable storage devices include small volume flash disk and big volume mobile hard disk which both use USB (universal serial bus) as power supply or to transmit data. Both the flash disk and the mobile hard disk have the advantages of small size, large capacity, cheap and high reliability, especially the flash disk is as small as a thumb and very light (normally 15 grams), so it is very convenient to carry, it can be hung from the neck, attached to the key ring, or can even be put in the wallet.

Referring to FIG. 1, a conventional USB type flash disk 10 comprises a memory device 11 and a cover 12. One end of the flash disk 10 is formed with an L-shaped hole 110 for hanging.

Although the hanging hole 110 of the flash disk 10 can be used for insertion of hanging string, the hanging string must be tied to key ring, bag or other objects, and then the flash disk 10 can be hung. The hanging string is useless when it is untied from the objects (the key ring or bag) to which the flash disk 10 is attached. Furthermore, the flash disk is very likely to be lost due to its small size.

The present invention has arisen to mitigate and/or obviate the afore-described disadvantages.

### SUMMARY OF THE INVENTION

The primary object of the present invention is to provide an easily-portable storage device which can also be used to carry small objects in addition to being used as storage device.

To achieve the abovementioned object, a portable storage device in accordance with the present invention comprises a memory device, a housing and a locking mechanism.

The memory device includes an upper and a lower covers, and a memory with one end clamped therebetween, each of the upper and lower covers is formed on its outer surface with an flange, and another end of the memory exposed out of the cover is an USB connector for connecting to computer;

The housing is provided for insertion of the connector of the memory and is provided with two ears at both sides thereof, around each of an upper and a lower edges of the housing is formed an arc-shaped flange for engaging with the flanges of the upper and lower covers, respectively, and each of the ears is formed with a through hole. A plurality of ribs is formed around an inner periphery of a bottom of the housing and is used to press against the connector of the memory when memory device is inserted in the housing.

The locking mechanism comprises a flexible member, and both ends of the flexible member being formed with a locking portion, each of the locking portions is inserted through the through holes of the ears and engaged with a locking members, respectively. The locking portions of the flexible member are formed with outer threads for meshing with inner threads of the locking member.

As compared with the conventional storage device, the present invention has the following advantages: besides used as a storage device, the present invention can also be used as key ring or to carry mini cards. When a key which is such an import thing to the user is attached to the storage device of the present invention, the user would keep it carefully, which reduces the risk of losing the storage device.

### BRIEF DESCRIPTION OF THE DRAWINGS

FIG. 1 is a perspective view of a conventional portable storage device;

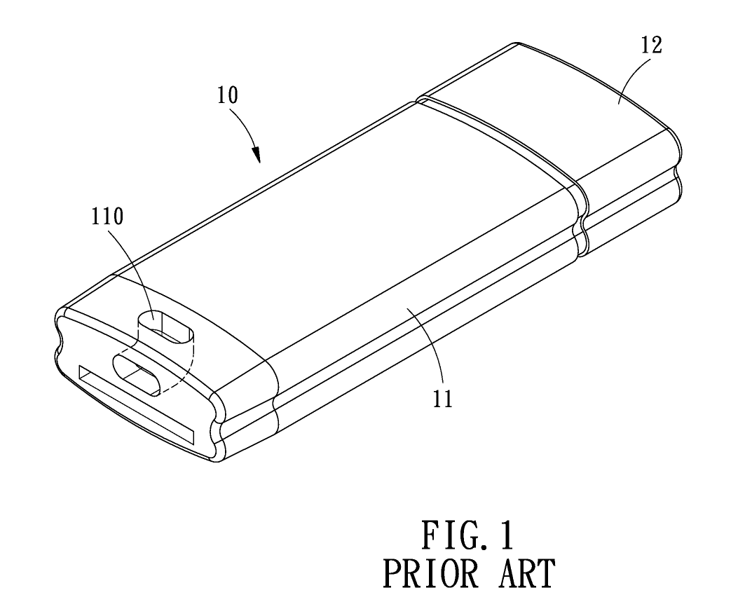

FIG. 2 is an exploded view of a portable storage device in accordance with the present invention;

FIG. 3 is a perspective view of the portable storage device in accordance with the present invention;

FIG. 4 is a cross sectional view of FIG. 3;

FIG. 5 is another cross sectional view of FIG. 3;

FIG. 6 is an operational view of the portable storage device in accordance with the present invention showing that a key is attached to the portable storage device; and

FIG. 7 is another operational view of the portable storage device in accordance with the present invention showing that a mini card is attached to the portable storage device.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

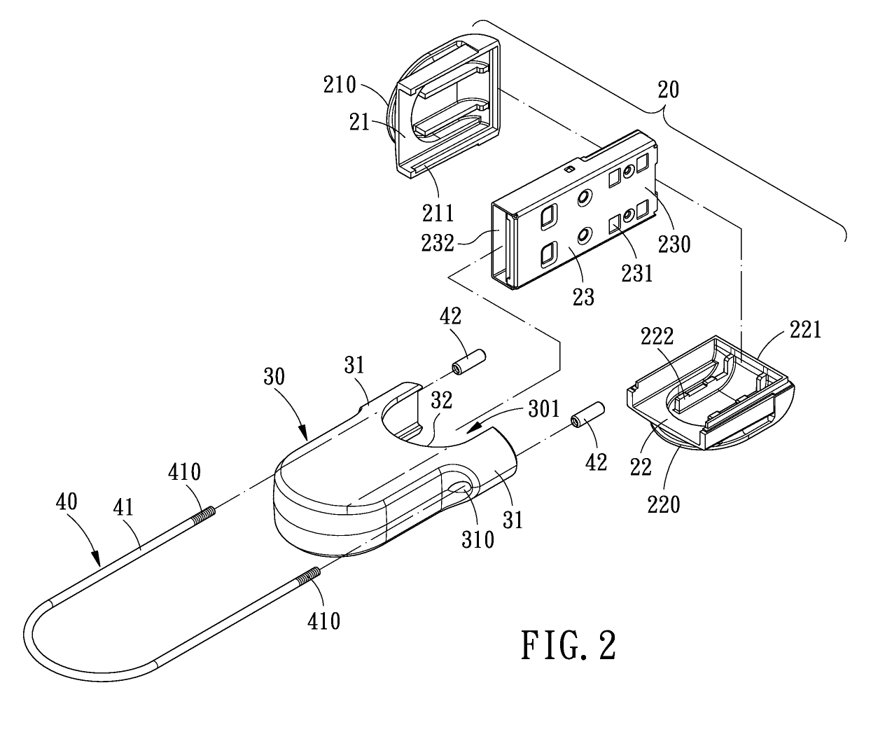

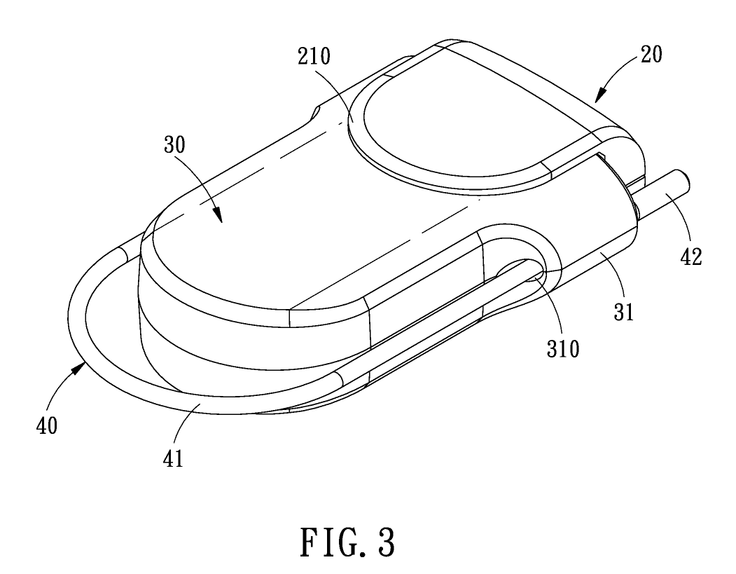

Referring to FIGS. 2 and 3, a portable storage device in accordance with the present invention comprises a memory device 20, a housing 30 and a lock mechanism 40.

The memory device 20 comprises an upper cover 21, a lower cover 22 and a memory 23. The upper and lower cover 21, 22 are oppositely concave-shaped to clamp one end 230 of the memory 23 therebetween. The upper cover 21 is formed on its outer surface with an arc-shaped flange 210, and around the inner periphery of the upper cover 21 is formed a groove 211. The lower cover 22 is also formed on its outer surface with an arc-shaped flange 220, around the inner periphery of the lower cover 22 is formed a flange 221 for engaging with the groove 211 of the upper cover 21, and on the inner surface of the lower cover 22 are formed a plurality of positioning protrusions 222. The end 230 of the memory 23 is clamped between the upper and lower covers 21, 22 in such a manner that one outer surface of the end 230 is formed with a plurality of positioning concaves 231 for engaging with the positioning protrusions 222 of the lower cover 22, the flange 221 of the upper cover 21 is engaged with the groove 211 of the upper cover 21, and then the jointing portion between the upper and lower covers 21, 22 is welded by high-frequency wave. The other end of the memory 23 is an USB connector 232 for connecting to computer.

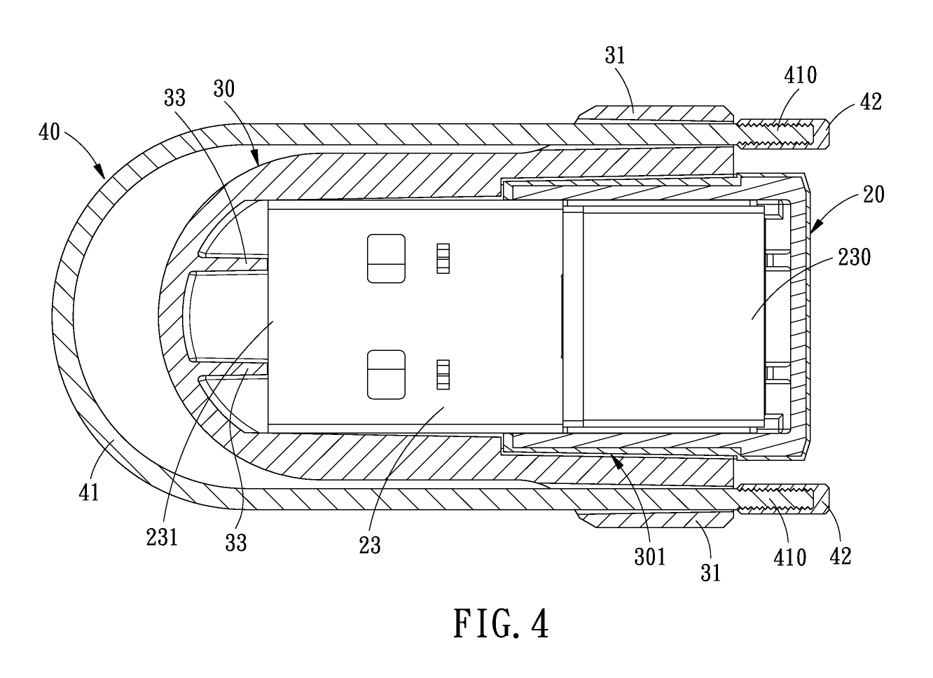

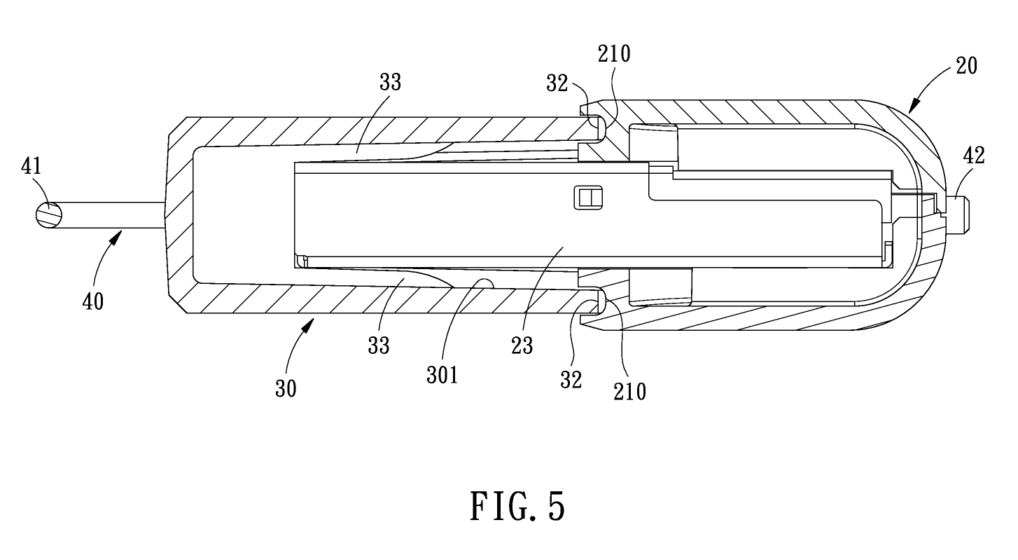

The housing 30 is formed with a concave 301 for insertion of the USB connector 232 of the memory 23 and is further provided with two ears 31 at both sides thereof. Each of the ears 31 is formed with a through hole 310, around each of the upper and lower edges of the concave 301 of the housing 30 is formed an arc-shaped flange 32 for engaging with the flanges 210, 220 of the upper and lower covers 21, 22, respectively. Referring to FIGS. 4 and 5, around the inner periphery of the bottom of the housing 30 are formed a plurality of ribs 33 which are used to provide a positioning effect by pressing against the USB connector 232 of the memory 23 when memory device 20 is inserted in the housing 30.

The locking mechanism 40 comprises a U-shaped flexible member 41 in the form of a steel cord or any normal cord, and both ends of the U-shaped flexible member 41 are formed with a locking portion 410 in the form of outer threads for meshing with a locking member 42 which is formed with inner threads. The locking portions 410 of the flexible member 41 are smaller in diameter than the through holes 310 of the housing 30, while the locking members 42 are larger in diameter than the through holes 310 of the housing 30. The two locking portions 410 are inserted through the through holes 310 and engaged with the locking members 42, so that the locking mechanism 40 is fixed to the housing 30.

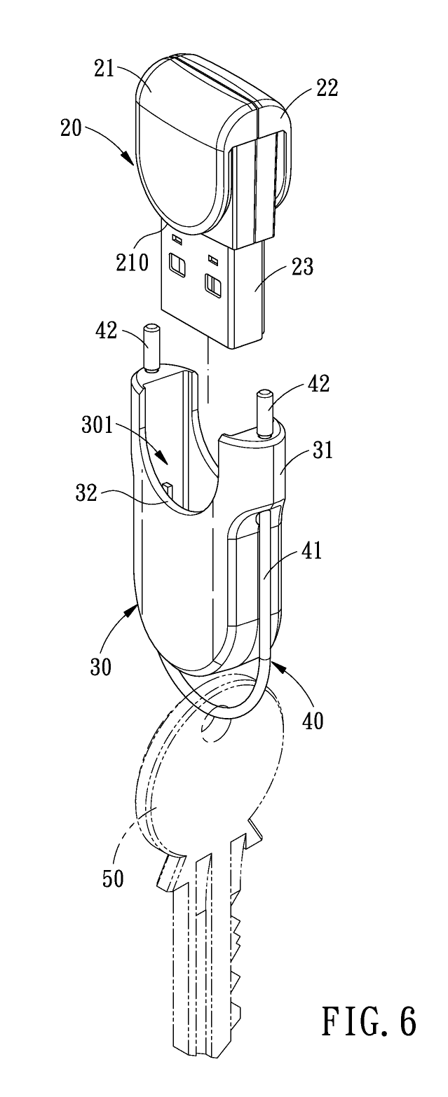

Referring to FIG. 6, since the flexible member 41 of the locking mechanism 40, the present invention can be used as a key ring simply by releasing one of the locking portions 410 from its corresponding locking member 42 and pulling it out of the through hole 310, then inserting the key 50 on the flexible member 41, and finally fixing the locking mechanism 40 to the housing 30 again.

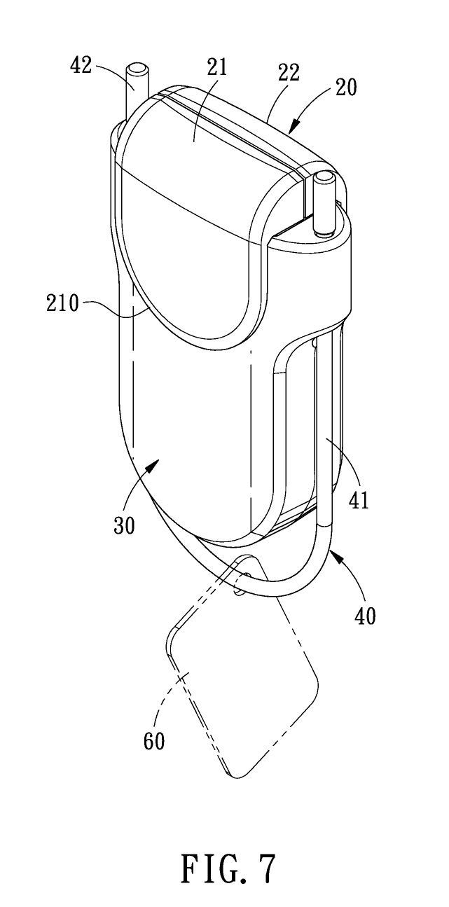

Referring then to FIG. 7, the present invention can also be used to carry mini card tags by repeating the same procedure as mentioned above.

Besides used as a storage device, the present invention can also be used as key ring or to carry mini cards. When a key which is such an import thing to the user is attached to the storage device of the present invention, the user would keep it carefully, which reduces the risk of losing the storage device.

While we have shown and described various embodiments in accordance with the present invention, it is clear to those skilled in the art that further embodiments may be made without departing from the scope of the present invention.

What is claimed is:

1. A portable storage device comprising:
a memory device including a cover and a memory with one end disposed in the cover, and another end of the memory exposed out of the cover being a connector for connecting to computer;
a housing for insertion of the connector of the memory being provided with two ears at both sides thereof, and each of the ears being formed with a through hole;
a locking mechanism comprising a flexible member, and both ends of the flexible member being formed with a locking portion, each of the locking portions being inserted through the through holes of the ears and engaged with a locking members, respectively.

2. The portable storage device as claimed in claim 1, wherein the cover comprises an upper and a lower cover, and the memory is clamped between the upper and lower covers, each of the upper and lower covers is formed on its outer surface with an flange.

3. The portable storage device as claimed in claim 2, wherein around each of an upper and a lower edges of the housing is formed an arc-shaped flange for engaging with the flanges of the upper and lower covers, respectively.

4. The portable storage device as claimed in claim 1, wherein the connector is a universal serial bus type connector for connecting to a computer.

5. The portable storage device as claimed in claim 1, wherein a plurality of positioning protrusions are formed on the cover for engaging with a plurality of positioning concaves formed on the memory.

6. The portable storage device as claimed in claim 1, wherein a plurality of ribs are formed around an inner periphery of a bottom of the housing and are used to press against the connector of the memory when memory device is inserted in the housing.

7. The portable storage device as claimed in claim 1, wherein the locking portions of the flexible member are formed with outer threads for meshing with inner threads of the locking member.
